(19) United States
(12) Patent Application Publication
(10) Pub. No.: US 2011/0208349 A1
(43) Pub. Date: Aug. 25, 2011

(54) ELECTRONIC POINT OF SALES VENDING CONTROL APPARATUS

(75) Inventors: Gerard Concannon, Claremorris (IE); Michael Cattigan, Ballaghaderreen (IE); John Henry, Glencar (IE); Sean Kenna, Claremorris (IE); James Forde, Claremorris (IE); Dominic Feeney, Westport (IE)

(73) Assignee: JANUARY PATENTS LIMITED, Claremorris (IE)

(21) Appl. No.: 12/673,535

(22) PCT Filed: Aug. 28, 2007
(86) PCT No.: PCT/EP07/58944

§ 371 Date: Feb. 15, 2010

(51) Int. Cl. G06F 17/00

(52) U.S. Cl. 700/236; 700/232; 700/237

(57) ABSTRACT

An electronic point of sales (EPOS) vending control apparatus for connecting different types of electronic point of sales (EPOS) systems with different types of vending machines is disclosed. The apparatus provides means for ensuring that the signals carrying control instructions for each EPOS system and vending machine connected to the control apparatus are in an appropriate format. The invention also ensures that one person is fully accountable for all vends originating from a particular EPOS system to provide one point of access and includes a verifiable audit trail. Each vend operation is recorded against a single authenticated operator.

The present invention relates to an electronic point of sales (EPOS) vending control apparatus for connecting different types of EPOS systems with different types of vending machines, each type of EPOS system and vending machine having characteristic control inputs.

Electronic point of sales (EPOS) systems are terminals used in place of conventional cash registers to facilitate both cash and card transactions, as well as to fulfill stock control and ordering requirements for retail outlets. The ability for EPOS systems to be networked to a centralised computer system also means that sales information for products and services sold by an outlet can be processed almost immediately.

The functionality of EPOS systems has also been extended to the control of vending machines. In this way products, such as cigarettes, stored in a vending machine coupled with the EPOS system can be dispensed by appropriate interaction of human operators with input means associated with the EPOS system during a transaction. Whereas previously, operators needed to interact with multiple devices to complete a transaction involving both vended products and other products, such functionality enables a transaction to be completed using a single EPOS system.

However, although such advances in EPOS technology are clearly advantageous, significant problems arise. One notable problem follows from the inability for these systems integrate the functionality of different types of EPOS systems. EPOS systems and vending machines each process quite different inputs and as a result the protocols and communication systems normally associated with them are very different. For example, EPOS systems will effectively control a vending machine through signals transmitted via its associated communications ports (such as RS232 or LAN). By comparison, internal control systems for vending machines use EPROM and firmware. Moreover, there are numerous brands, makes and models of EPOS systems available on the market, each having their own respective processing systems and each requiring specific control inputs. Furthermore, different types of EPOS systems will also generate different output signal which are characteristic of the system type. Similar problems also follow for different types of vending machines which will require characteristic control inputs for their control and will produce outputs which are characteristic of the vending machine type. A technical problem thus exists in that it is not possible to integrate the functionality of different types of EPOS systems with different types of vending machines.

Further problems in present EPOS systems follow from the inability for such systems to provide full accountability for each product dispensed from a vending machine under the control of a particular EPOS system. It will be appreciated that such a lack in traceability of vended products will give rise to significant instances of fraud within outlets, it being widely known that fraud has been a long term problem for retailers who sell small expensive low margin packed products, such as cigarettes, confectionary and razor blades.

Historically, vending initially involved the use stand alone un-manned machines selling small packed products such as confectionary, tobacco products and razor blades. In use, a customer would insert the indicated payment and select the desired product. Although this method of selling provided a relatively secure and safe method for vending, as the vending machine is typically robust and the payment is received before the product was vended, there were no controls on who may obtain products from the vended machine. Accordingly, these systems were accessible by underage persons who are not legally entitled to purchase certain products, notably, tobacco products. These machines also fail to provide full accountability for dispensed products.

In other vending machines, the product is vended before payment is made. In such machines there is significant scope for fraud by customers and by operators. Compounding the problem is the fact that numerous people can be involved in a single transaction and this makes it more difficult for offending persons to be detected. Moreover, such systems do not in any way contribute to preventing the fraud from occurring in the first place. A significant issue arises as operators, although having control of vending machines, do so without any accountability as to products that have been vended. For example, an operator can perform a vend without registering the sale, or can perform multiple vends and only charge for some of them. Another opportunity for fraud arises where an operator may vend a product without paying. Additionally, customers may make erroneous vends and there is no accountability for the vended product. Moreover, erroneously vended products may be stolen by the customer, cashier or any other opportunist who may discover them.

Accordingly, there are numerous occasions which may result in a fraud being committed in such arrangements for vending machines.

Associated with other forms of vending machines are secondary keyboards. These allow the operator to perform the required actions to vend the desired product. In some embodiments the keyboard is connected to an EPOS system. However, these arrangements are also prone to fraud as the EPOS system may be deactivated by operators and this will result in the transaction not being recorded.

It is a therefore an object of the present invention to provide an EPOS vending control apparatus for connecting at least one EPOS system with at least one vending machine which overcomes the above problems and/or which will provide the public and/or industry with a useful alternative.

It is acknowledged that the term ‘comprise’ may, under varying jurisdictions be provided with either an exclusive or inclusive meaning. For the purpose of this specification, and unless otherwise noted explicitly, the term comprise shall have an inclusive meaning—i.e. that it may be taken to mean an inclusion of not only the listed components it directly references, but also other non-specified components. Accordingly, the term ‘comprise’ is to be attributed with as broader interpretation as possible within any given jurisdiction and this rationale should also be used when the terms ‘comprised’ and ‘comprising’ are used.

Further aspects of the present invention will become apparent form the ensuing description which is given by way of example only.

Accordingly, there is provided an electronic point of sales (EPOS) vending control apparatus for connecting different types of electronic point of sales (EPOS) systems with different types of vending machines, each type of EPOS system and vending machine having characteristic control inputs,

characterised in that the control apparatus comprises a main vending control unit connected to at least one vending machine and at least one EPOS system by a communications link for the transmission of characteristic EPOS control input signals for controlling the EPOS system and characteristic vending machine control input signals for controlling the vending machine from the EPOS system,

the control apparatus operating an adaptive EPOS communications interface for translating standardised EPOS control input signals transmitted from the main vending control unit into characteristic EPOS control input signals for transmission to the EPOS system, and an adaptive vending machine communications interface for converting standardised vending machine control inputs signals transmitted from the main vending control unit into characteristic vending machine control input signals for transmission to the vending machine.

The present invention provides an arrangement in which standardised control input signals transmitted from the main vending control unit are able to be translated into characteristic signals suitable for supply as control inputs to each type of EPOS system and vending machine connected to the control apparatus. This will enable different types of EPOS system's and vending machines to be integrated for use together. The EPOS vending control apparatus may be configured as a computing server which is locatable either locally within an outlet or remotely, for example at a head office location.

Specifically, the provision of an adaptive EPOS communications interface which translates standardised EPOS control input signals transmitted from the main vending control unit into characteristic EPOS control input signals for transmission to the EPOS system will ensure that the signals carrying control instructions for an EPOS system are in the correct format suited to the particular EPOS system concerned. This will enable the retrofitting of new types of EPOS systems into a retail outlet without having to remove older version EPOS systems.

Similar advantages follow from the provision of the adaptive vending machine communications interface. In particular, translating vending machine control input signals transmitted from the main vending control unit into characteristic vending machine control input signals for the desired vending machine will facilitate dispensing of products from a particular vending machine coupled to the EPOS system via the control apparatus. The adaptive vending machine communications interface will thus facilitate the ability for vending machines of different types to be controlled by an EPOS system coupled to the control apparatus. Furthermore, a vended product can be, and quite often is, part of a basket of various non-vended products in one sale. A vend can thus be made at any stage of the overall transaction.

In another embodiment of the invention, the adaptive EPOS communications interface is further configured to translate characteristic EPOS control output signals transmitted from the EPOS system into standardised EPOS control output signals for processing by the main vending control unit.

Such a provision will enable control output signals received from the EPOS system to be processed by the main vending control unit. In this way, instructions to vend a product from a specific vending machine can be encoded by vending software applications executing on the EPOS system into a characteristic EPOS control output signals for transmission initially to the adaptive EPOS communications interface. At the adaptive EPOS communications interface these characteristic EPOS output signals can be translated into standardised EPOS control output signals for processing by the main vending control unit.

Preferably, the adaptive vending machine communications interface is further configured to translate characteristic vending machine control output signals transmitted from the vending machine into standardised vending machine control output signals for processing by the main vending control unit.

Such a provision will enable control output signals received from the vending machine to also be processed by the main vending control unit.

In another embodiment of the invention, the main vending control unit is connected to a database of interface control programs.

In such an embodiment, an interface control program, when executed on the EPOS communications interface, provides functionality required to generate characteristic EPOS control input signals and to process characteristic EPOS control output signals for an EPOS system.

In a further an embodiment, another of said interface control programs, when executed on the vending machine communications interface, provides functionality required to generate characteristic vending machine control input signals and to process characteristic vending machine control output signals for a vending machine.

Preferably, associated with the database of interface control programs is an EPOS configuration file which stores configuration parameters which are provided as input to the interface control programs.

Preferably, the interface control programs are arranged in the database in a dynamic linked library structure.

Such a structure will ensure that all of the EPOS systems and vending machines that are integrated with the EPOS vending control apparatus can share the code associated with each control program and any configuration parameters.

In another embodiment of the invention, the EPOS vending control apparatus further comprises means for sampling characteristic EPOS control output signals for an EPOS system on connection to the EPOS vending control apparatus, and means for extracting EPOS system identification parameters from the sampled EPOS signals.

Preferably, the EPOS vending control apparatus uses the EPOS system identification parameters to select and write an interface control program to the adaptive EPOS communications interface to facilitate processing of characteristic EPOS control output signals received from the EPOS system and generating characteristic EPOS control input signals for the EPOS system.

In another embodiment of the invention, the EPOS vending control apparatus further comprises means for sampling characteristic vending machine control output signals for a vending machine on connection to the EPOS vending control apparatus, and means for extracting vending machine identification parameters from the sampled vending machine signals.

Preferably, the EPOS vending control apparatus uses the vending machine identification parameters to select and write an interface control program to the adaptive vending machine communications interface to facilitate processing of characteristic vending machine control output signals received from the vending machine and generating characteristic vending machine control input signals for processing by the vending machine.

In another embodiment of the invention, the adaptive EPOS communications interface and the adaptive vending machine communications interface are stored on the control apparatus.

Preferably, the adaptive communications interfaces each comprise means for extracting point of sales terminal data and/or vending machine data from the characteristic EPOS control output signals received from the EPOS systems and/or the characteristic vending machine control output signals received from vending machines coupled to the control apparatus.

Preferably, the extracted point of sales device data and/or vending machine data is transmitted to the main vending control unit.

In another embodiment of the invention, the main vending control unit is connected to at least one hub computer via a further communications link for the transmission of the point of sales data and vending machine data.

Preferably, the point of sales data and vending machine data includes data relating to transactions including both products vended from a vending machine and other non-vended products in a transaction.

In another embodiment of the invention, the point of sales data and vending machine data transmitted from the main vending control unit is time and/or date stamped according to the time and date of the transaction.

Preferably, the hub computer is able to process the point of sales data and vending machine data into reports detailing sales activity and/or the dispensing activity of one or more vending machines.

Such reports may be related to failed vend requests and will enable operators as well as head office personnel to react quickly to hardware problems with vending machines. The reports will highlight problems with vending machines where particular columns or slots give vend failures and they will also highlight problems with vending machines that fail to vend any product.

In another embodiment of the invention, an operator must input authentication information to an EPOS system in order to operate and gain access to the functionality of the EPOS system.

By requiring an operator to input authentication information the apparatus ensures that one person is fully accountable for all vends originating from a particular EPOS system. Such a provision ensures that there is one point of access and includes a verifiable audit trail.

Preferably, authentication of an operator involves the operator inputting a password into a login or verification routine running on an EPOS system. Alternatively, authentication of an operator involves the operator passing a swipe card through a reader associated with the EPOS system, whereby the required verification information is obtainable from the swipe card by the reader and then transmitted to the EPOS system. Authentication may also include biometric methods, such as finger print readers or iris scanning technologies.

In another embodiment of the invention, instructions for the vending machine to dispense a product for a transaction are initially encoded in a characteristic EPOS control output signal transmitted from an EPOS system connected to the control apparatus.

Preferably, each EPOS system operates a vending machine control application which provides an interactive interface on the EPOS system from which operators can select a product to be dispensed from a vending machine.

Preferably, the EPOS system comprises a touch screen and the interactive interface is icon based, each product able to be dispensed from the vending machine being represented as an icon on the touch screen.

Use of a touch screen will also enable management to configure the touch panels on the EPOS system with all information corresponding to the layout of the columns and/or slots in a vending machine.

In this way the EPOS system that has complete control of the vend process.

Alternatively, an EPOS system comprises a keyboard and each product is able to be dispensed from the vending machine by pressing a predefined key on the keyboard.

Preferably, in the event that a specific vending machine is unable to vend a requested product the vend request is directed to an alternative vending machine to dispense the requested product. Thus, if a vending machine is faulty or out of stock the initial vend request can be directed to another vending machine connected to the EPOS vending control apparatus which is capable of fulfilling the vend request.

Preferably, before the costs for the dispensed product are added to a customer invoice the EPOS system must receive a characteristic EPOS control input signal encoding a confirmation that the vending machine has dispensed the product.

Preferably, when such a confirmation is received it is rendered on display means associated with the EPOS system.

The EPOS system thus not only issues signals to the vending machine to vend a particular product when instructed to do so by the operator, but also waits for confirmation of a successful vend before it adds the cost of the product to the customers transaction invoice. Each vend operation is therefore recorded, but more significantly is recorded against a single authenticated operator.

Preferably, each vend from a vending machine is recorded against the operator issuing the vend instruction from the EPOS system.

In another embodiment of the invention, the EPOS system comprises customer age verification functionality.

The provision of age verification functionality on the EPOS system will prompt the operator to get the customer to verify their age before allowing a transaction to proceed. When an operator requests that the vending machine vend a product, the EPOS system will prompt the operator to confirm and then record the confirmation that the customer is old enough to purchase the desired goods.

Preferably, the customer age verification functionality involves each EPOS system issuing a visual prompt on the display means instructing the operator to request a customer to produce age verification. Such age verification may be provided as an identity card.

Alternatively, the customer age verification functionality involves scanning a card encoding the age of the customer. Preferably, the EPOS system is adapted to store details relating to age verification of a customer.

In another embodiment of the invention, the EPOS system maintains a personal details database comprising personal details of each operator. Preferably, access to functionality on each EPOS system needed to vend specific products from a vending machine is controllable according to personal details of the operator in the database.

Preferably, the main control unit receives data relating to all vended products once they have been dispensed from the vending machine.

In another embodiment of the invention, the main vending control unit comprises means to monitor the quantity of each product in a vending machine.

Preferably, the main vending control unit comprises means to transmit alerts in response to signals received from the vending machine indicating that levels of product remaining in the vending machine are below a minimum specified level.

Preferably, such alerts are in the form of a prompt on an EPOS system, a simple messaging service (SMS) text message and/or an e-mail message.

In another embodiment of the invention, the main vending control unit is adapted to transmit status information to a web-server to facilitate online remote monitoring of vending machines in a single or multiple locations.

In another embodiment of the invention, touch panels associated with an EPOS system are configurable to present a graphical representations corresponding to the physical layout of products in the vending machine.

Preferably, an EPOS operator will be able to select a product to be vended by touching a graphical representation on the touch screen corresponding to the product.

### DETAILED DESCRIPTION OF THE INVENTION

The invention will be more clearly understood from the following description of some embodiments thereof, given by way of example only, with reference to the accompanying drawings, in which:

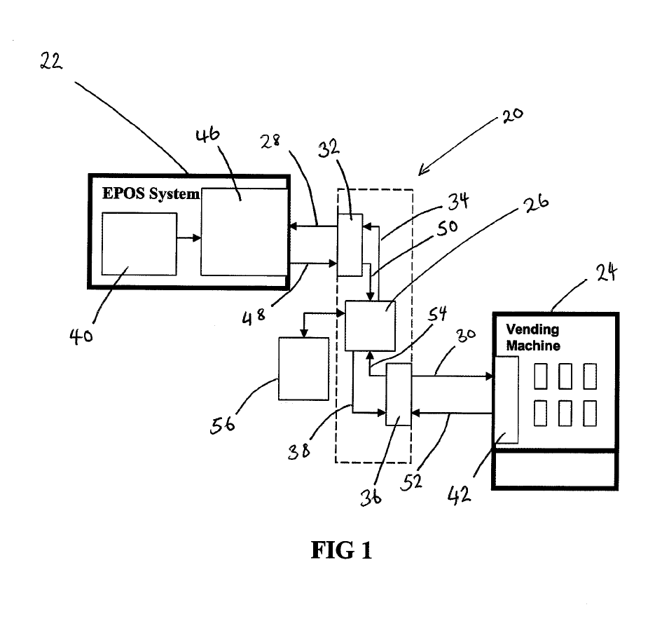

FIG. 1 is a schematic view of an EPOS vending control apparatus according to the present invention;

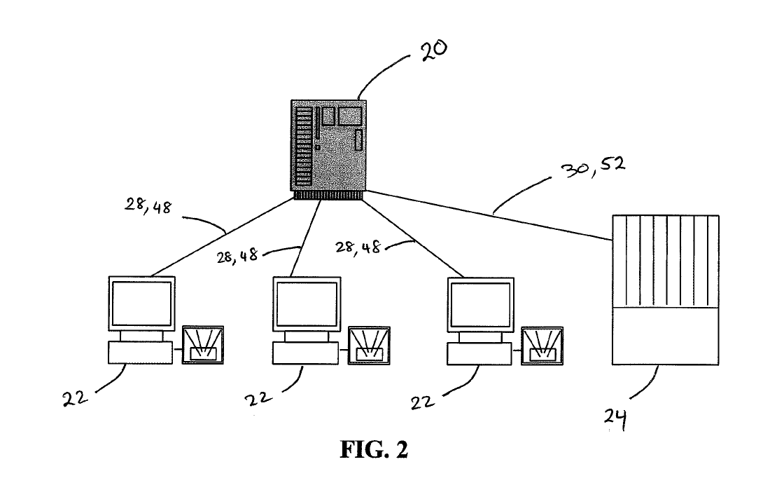

FIG. 2 is a schematic views of an alternative configuration of EPOS systems and vending machines for use according to the present invention;

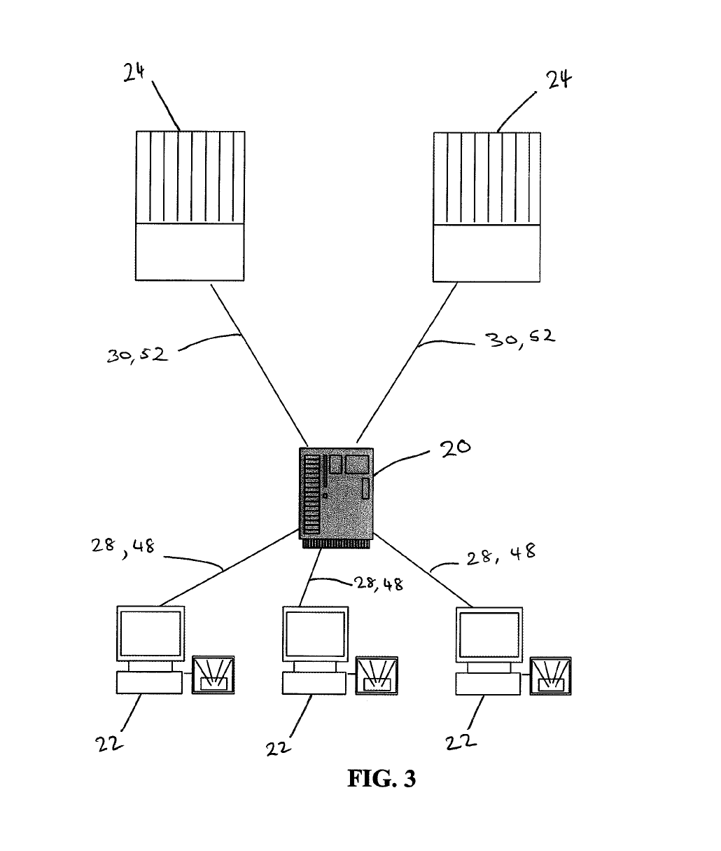

FIG. 3 is a schematic view of a further alternative configuration of EPOS systems and vending machines for use according to the present invention;

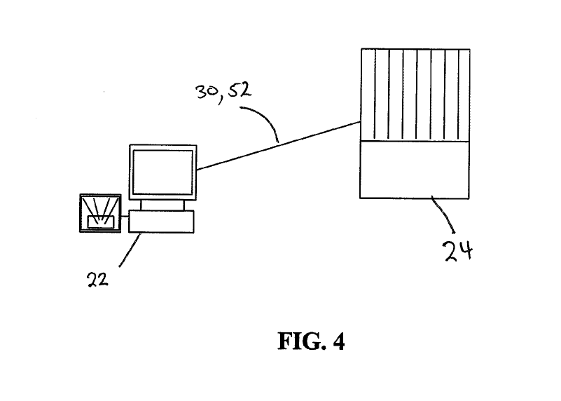

FIG. 4 is a schematic view of a still further alternative configuration of EPOS systems and vending machines for use according to the present invention;

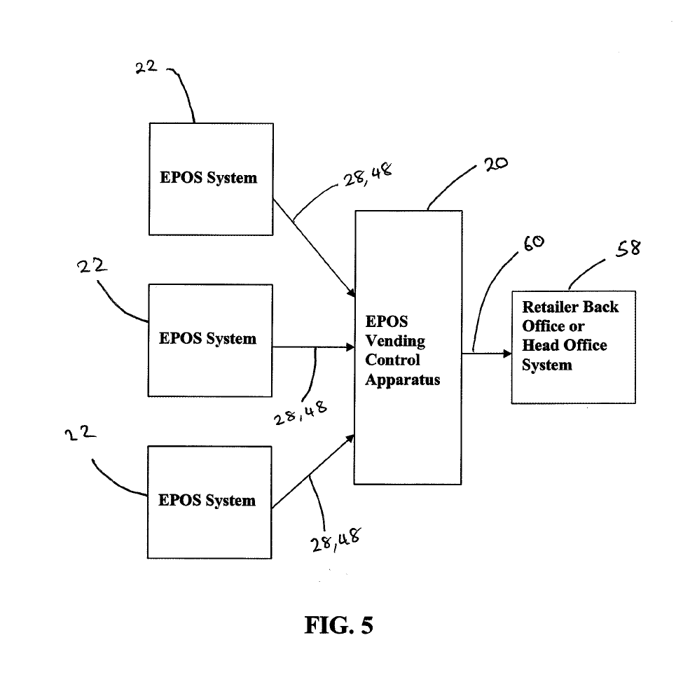

FIG. 5 is a schematic view of a number of EPOS systems connected to a hub computer via the EPOS vending control apparatus configured according to the present invention;

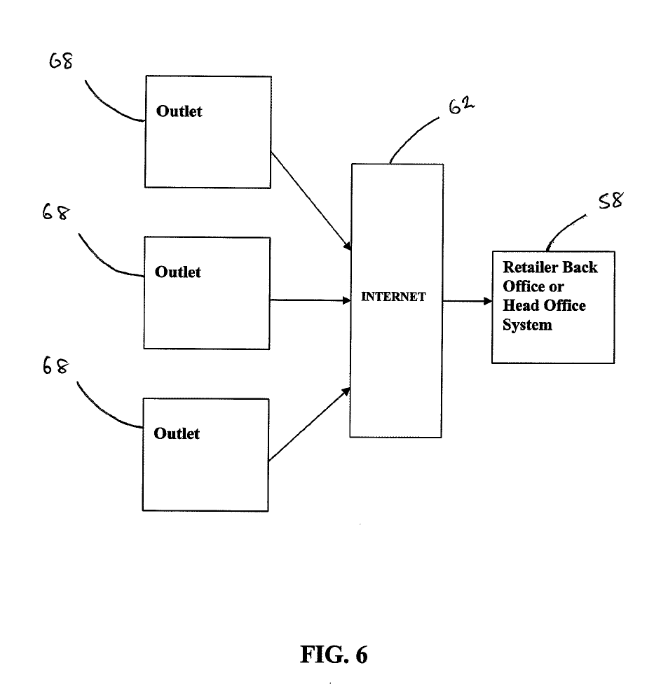

FIG. 6 is a schematic view showing the connectivity of a number of outlets to the hub computer via a network,

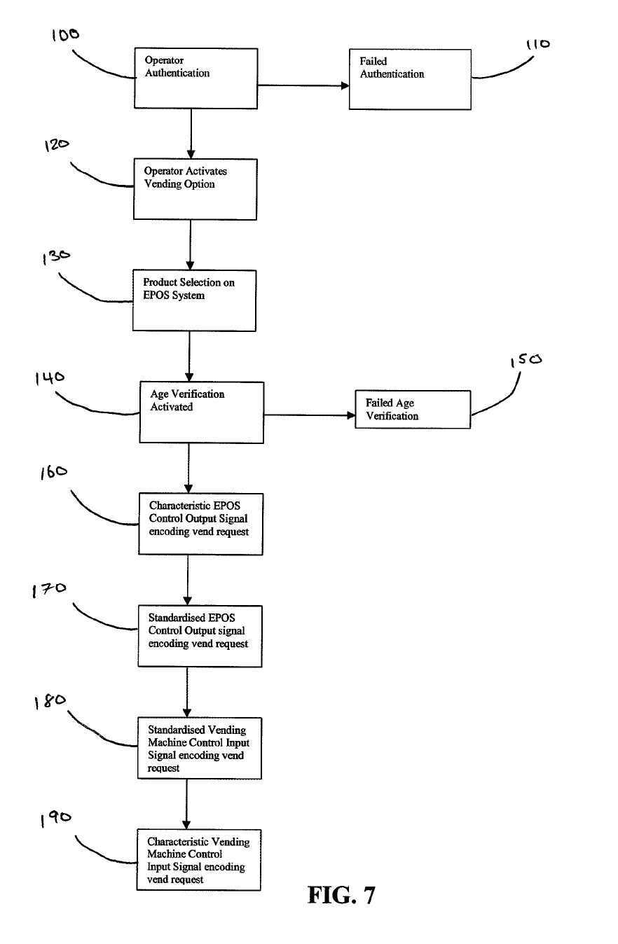

FIG. 7 is the first part of a flow diagram showing the steps in a process for vending a product according to the invention;

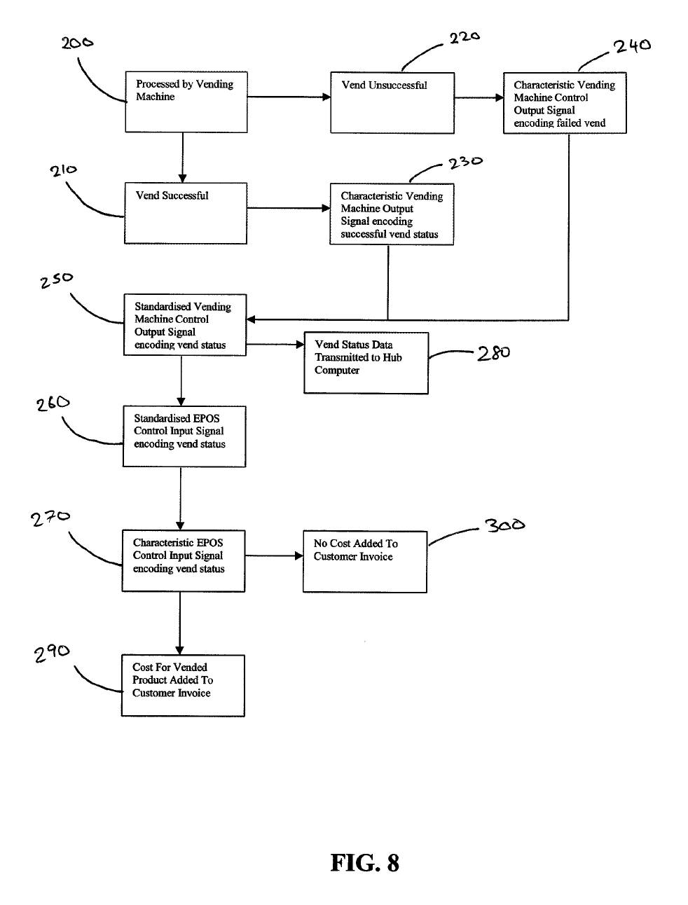

FIG. 8 is the second part of the flow diagram shown in FIG. 7;

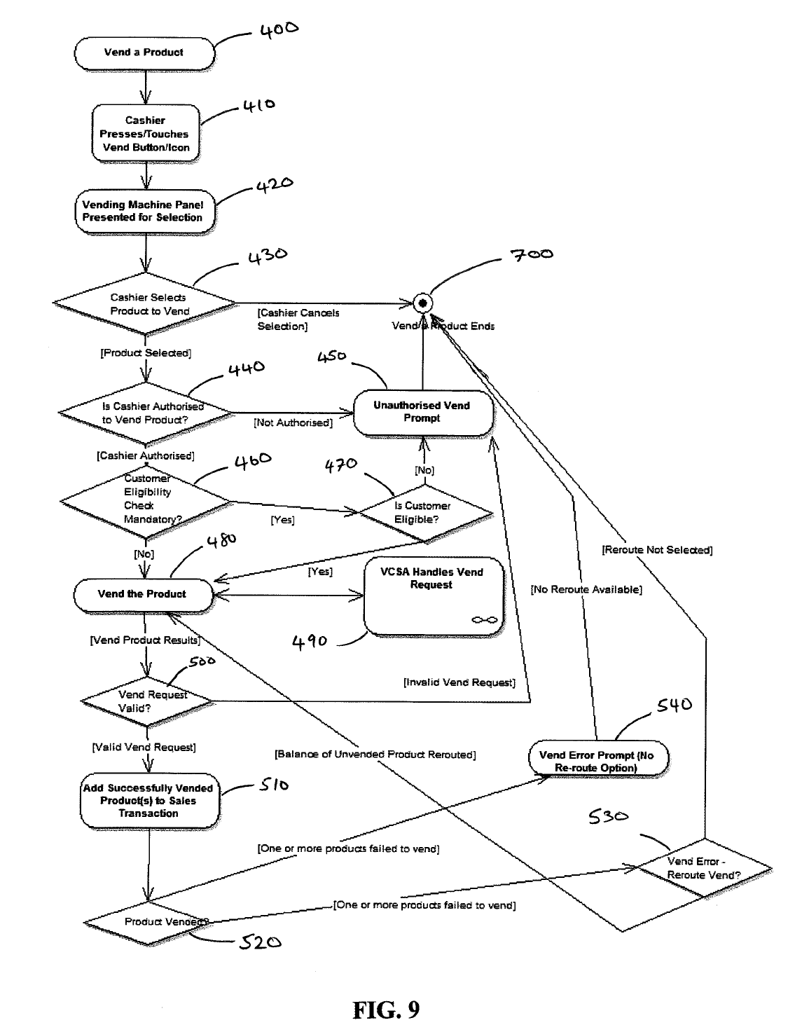

FIG. 9 is a further flow diagram showing the steps in a process for vending a product according to the invention;

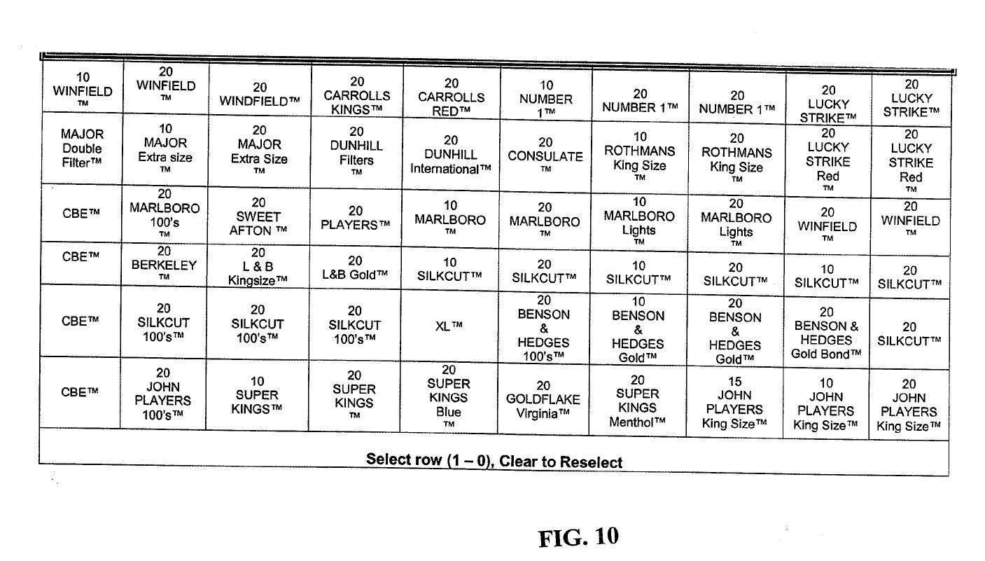

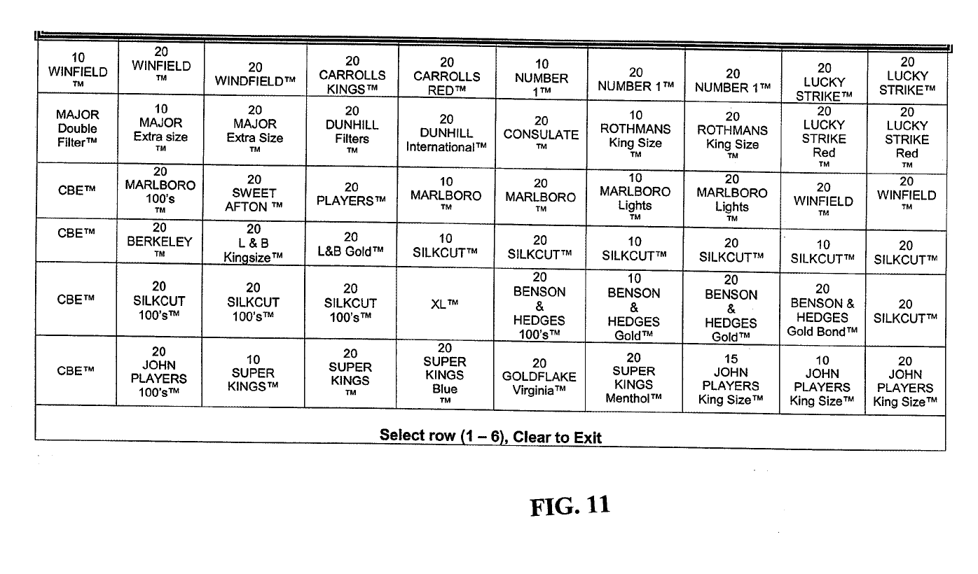

FIGS. 10 and 11 show optional drop down menu functionality of an EPOS system connected the EPOS vending control apparatus shown in FIG. 1, and

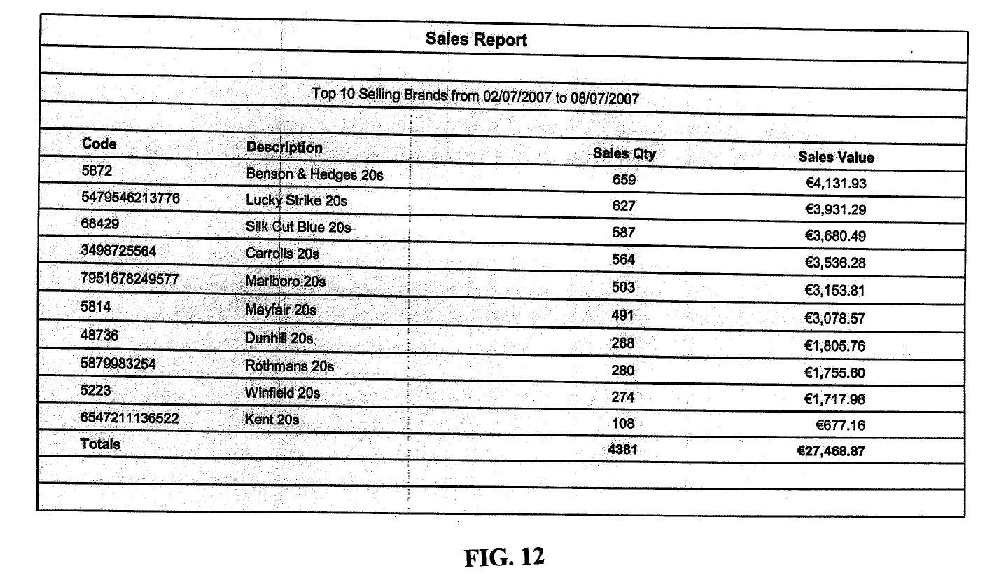

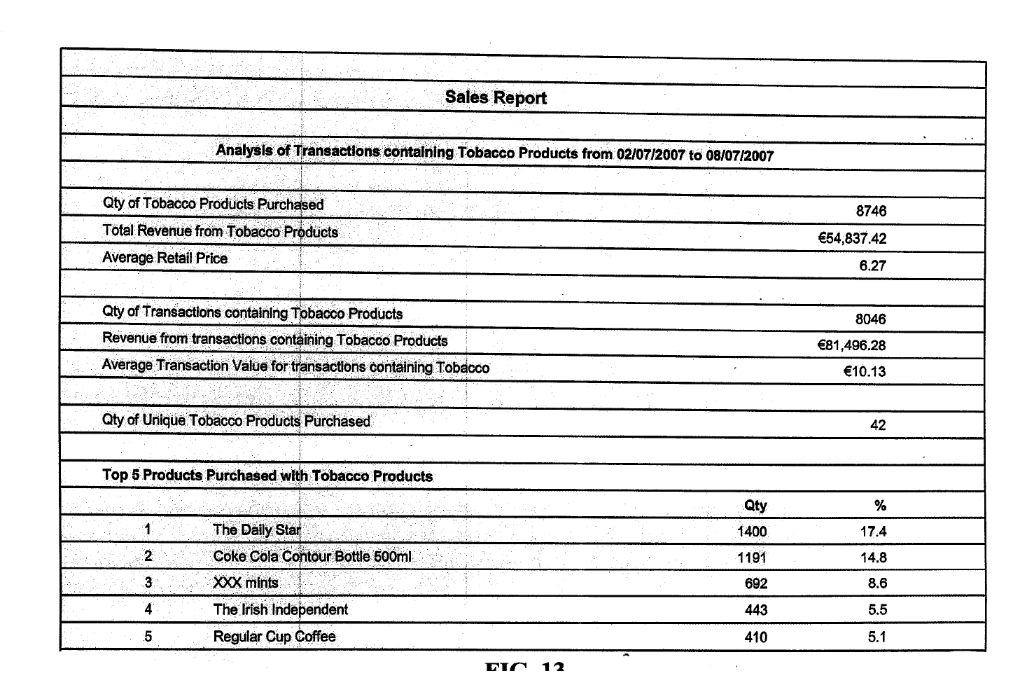

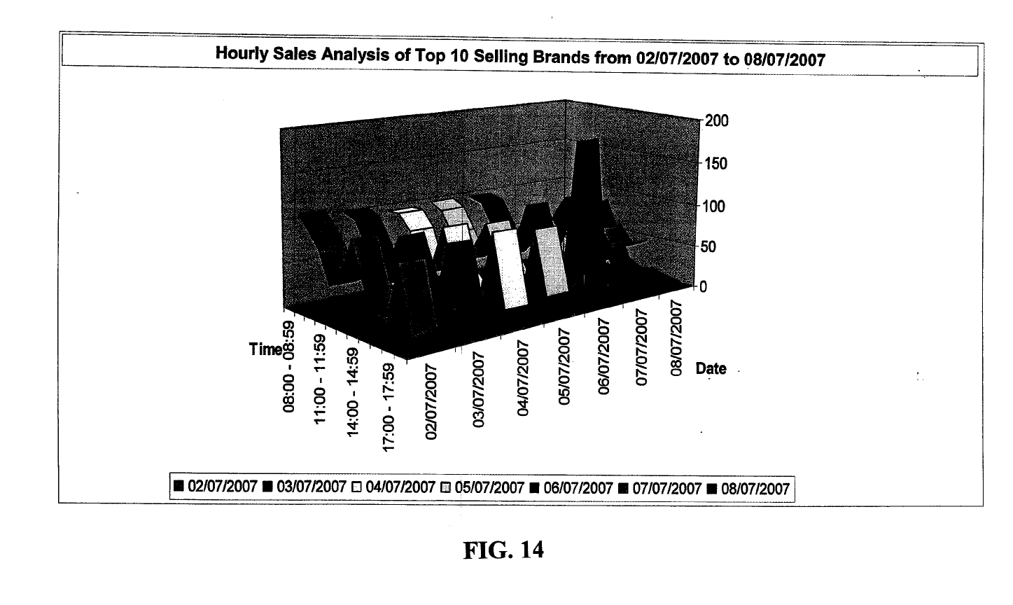

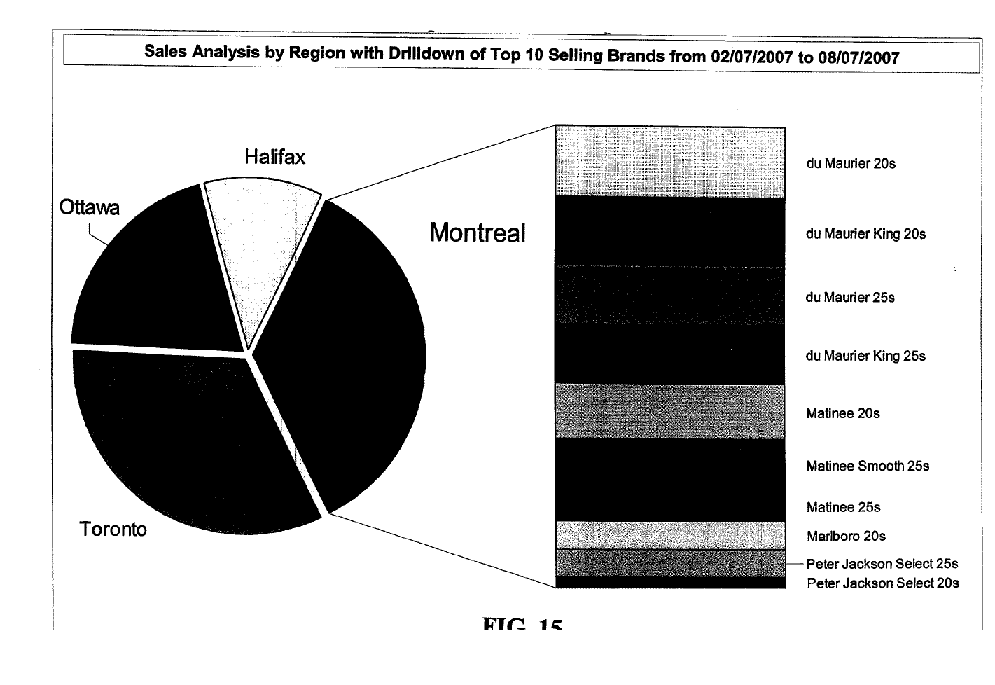

FIGS. 12 to 15 show sample reports which are able to be generated by the hub computer from point of sales and vending machine data according to the present invention.

For the purposes of the foregoing description, the term “operator” should be understood to mean a person in an outlet who interacts with an EPOS system in order to initiate vends from vending machines, total the amount due for the purchase of products and/or services from the outlet, charges the customer for the amount and processes a card or cash transaction by way of payment for the purchase.

The term “characteristic” in the context of input and output signals should be understood to mean signals which are capable of being processed or generated by a specific EPOS system or vending machine. For example, a characteristic vending machine control input signal will be understood as being an input signal which is able to be supplied as input to a specific vending machine in the EPOS network so as to direct and control specific functionality at that vending machine. A characteristic vending machine control input signal capable of being supplied as input to one type of vending machine will not be suitable for supply as input to another type of vending machine. Similarly, a characteristic EPOS control output signal will be understood as being an output signal transmitted from a specific EPOS system. Different EPOS system will thus produce different characteristic EPOS control output signals

The term “standardised” in the context of input and output signals should be understood to mean generic signals which are in a format capable of being processed or generated by the main vending control unit of the present invention. Specifically, the characteristic signals output by the various types of EPOS systems and vending machines connected to the control apparatus must first be translated into a standardised format able to be interpreted by the control apparatus

Referring to the drawings, and initially to FIG. 1, there is shown an EPOS vending control apparatus, indicated generally by the reference numeral 20, for connecting different types of electronic point of sales (EPOS) systems 22 with different types of vending machines 24. The control apparatus 20 comprises a main vending control unit 26 which is connected to at least one vending machine 24, and at least one EPOS system 22, by a communications link 28 for the transmission of characteristic EPOS control input signals for controlling the EPOS system 22 and a communications link 30 for transmitting characteristic vending machine control input signals for controlling the vending machine 24 from the EPOS system 22.

Although FIG. 1 shows a single EPOS system 22 being connected via the main vending control unit 26 to the vending machine 24, it will be appreciated that the present invention is configurable to integrate the functionality of any number of EPOS systems 22 with any number of vending machines 24. For example, and referring briefly to FIG. 2, shown is an arrangement in which multiple EPOS systems 22 are connected to a single vending machine 24 via the control apparatus 20. FIG. 3 shows the configuration of FIG. 2 in which multiple vending machines 24 are coupled to the control apparatus 20. FIG. 4 shows another possible arrangement in which the control apparatus 20 is integrated with an EPOS system 22 into a single machine and connected to a vending machine 24. Although not shown, further configurations may include a single main vending control unit integrated onto a single EPOS system and being interfaced to multiple vending machines. Another configuration may also include multiple vending control units for redundancy. It will therefore be understood that numerous configurations for EPOS systems and vending machines are contemplated by the present invention and are not limited to that shown in FIG. 1.

Referring again to FIG. 1, the control apparatus 20 operates an adaptive EPOS communications interface 32 for translating standardised EPOS control input signals transmitted from the main vending control unit 26 via communication link 34 into characteristic EPOS control input signals for transmission to the EPOS system 22 via communications link 28. Also shown is an adaptive vending machine communications interface 36 for converting standardised vending machine control input signals transmitted from the main vending control unit 26 via communications link 38 into characteristic vending machine control input signals for transmission to the vending machine 24 via communications link 30.

The EPOS system 22 comprises processing means 40 and the vending machine 24 comprises processing means 42. Executing on the main vending control unit 26 is vending control server software which can be deployed with connectivity to both the EPOS system 22 and the vending machine 24 via the communications interfaces 32, 36. Various software based library modules are able to be deployed at the main vending control unit 26. The vending control server software may be deployed on a LAN or via a TCP/IP connection or directly on the main vending control unit 4.

Associated with the EPOS system 22 is an application programming interface 46 (API) which not only facilitates communications between the EPOS vending control apparatus 20 and the EPOS system 22, but also enables a developer to add vending processing functionality to the EPOS system 22. This functionality is aided by number of software modules associated with the application programming interface 46 which are organised in a dynamic linked library structure. Such a dynamic linked library encapsulates the signal construction and deconstruction processes at the EPOS system 22, and also a configuration file which holds such details as the modes of communication available to the EPOS system 22, such as whether the communication should be file based (FTP), TCP/IP or by wireless communications.

The adaptive EPOS communications interface 32 is further configured to translate characteristic EPOS control output signals transmitted from the EPOS device via communications link 48 into standardised EPOS control output signals which are transmitted via communications link 50 for processing by the main vending control unit 26. Similarly, the adaptive vending machine communications interface 36 is further configured to translate characteristic vending machine control output signals transmitted from the vending machine via communications link 52 into standardised vending machine control output signals, which are transmittable via communications link 54 for processing by the main vending control unit 26. The adaptive EPOS communications interface 28 and the adaptive vending machine communications interface 36 are stored on the control apparatus 20, although it will be appreciated that other configurations are also possible.

An operator (not shown) must initially input authentication information to an EPOS system 22 in order to operate and gain access to its functionality. Such authentication may involve the operator inputting a password into a login or verification routine running on EPOS system 22. Alternatively, authentication of an operator may involve the operator passing a swipe card through a reader associated with the EPOS system 22, whereby the required verification information is obtainable from the swipe card and then transmitted to the EPOS system 22. It will be understood that each vend from a vending machine 24 is recorded against the operator issuing a vend instruction from a specific EPOS system 22.

Each EPOS system 22 comprises customer age verification functionality and such functionality may involve each EPOS system 22 generating a visual prompt on the display means instructing the operator to request a customer to produce age verification. Such age verification may be an identity card. The customer age verification functionality may also involve scanning a card associated with the customer encoding the age of the customer. The EPOS system 22 may also be adapted to store details relating to age verification of a customer, and may also maintain a personal details database comprising personal details of each operator. Additionally, access to functionality on each EPOS system 22 needed to vend specific products from a vending machine 24 is controllable according to personal details of the operator in the database.

A vending machine control application operating on each EPOS system 22 is configured to generate an interactive interface on the EPOS system 22 from which operators can select a product to be dispensed from a vending machine 24. Each EPOS system 22 may also comprise a touch screen and the interactive interface is icon based so that each product able to be dispensed from the vending machine 24 is represented as an icon on the touch screen. The touch panels associated with an EPOS system 22 are configurable to present graphical representations corresponding to the physical layout of products in the vending machine 24 so that an operator will be able to select a product to be vended by touching a graphical representation on the touch screen corresponding to the product. Furthermore, icons representing each individual vending machine 24 which is able to receive a vending instruction from an EPOS system 22 connected to the main vending control unit control apparatus 20 may be displayed on display means associated with the EPOS system 22. In this way an operator is able to quickly identify a product to be vended by initially selecting the required vending machine 24 which is adapted to dispense the required product.

FIGS. 10 and 11 show representations of drop down menus which may also be provided on display means associated with each EPOS system 22 according to the invention. Such drop down menus will enable an operator to avoid having to scroll through lists of vendible products on the display means or touch screen. In operation, the operator presses the required button on the keyboard, or an icon on a touch screen, corresponding to a category of products, such as cigarettes. Once selected, the screen shown in FIG. 9 is displayed. The operator may select the relevant row by pressing the number corresponding to that row. This then activates the screen shown in FIG. 11. The operator then selects the relevant column by pressing the number corresponding to that column. The process to then dispense that selected product from the vending machine is then activated.

From the EPOS system 22 operators are thus able to maintain complete control of the vend process. Conversely, the EPOS system 22 comprises a keyboard and each product is able to be dispensed from the vending machine 24 by pressing a predefined key on the keyboard. Before the costs for the dispensed product are added to a customer invoice the EPOS system 22 must receive a characteristic EPOS control input signal encoding a confirmation that the vending machine has dispensed the product. Preferably, such a confirmation is displayed on display means associated with the EPOS system 22.

The adaptive EPOS communications interface 32 and the adaptive vending machine communications interface 36 are coupled, via the main vending control unit 26, to a database 56 of interface control programs.

Such interface control programs, when executed on the EPOS communications interface, may provide functionality required to generate characteristic EPOS control input signals and to process characteristic EPOS control output signals for an EPOS system. Other of said interface control programs, when executed on the vending machine communications interface, may provide the functionality required to generate characteristic vending machine control input signals, and to process characteristic vending machine control output signals for a vending machine.

Associated with the database 56 of interface control programs is an EPOS configuration file which stores configuration parameters which are provided as input to the interface control programs. The interface control programs are arranged in the database 56 in a dynamic linked library structure.

The EPOS vending control apparatus 20 further comprises means for sampling characteristic EPOS control output signals for an EPOS system 22 on connection to the EPOS vending control apparatus 20. Also provided is means for extracting EPOS system identification parameters from the sampled EPOS signals. In this way the EPOS vending control apparatus 20 uses the extracted EPOS system identification parameters to select and write an interface control program to the adaptive EPOS communications interface 32 to facilitate processing of characteristic EPOS control output signals received from the EPOS system 22 and generating of characteristic EPOS control input signals for processing by the EPOS system 22.

Similarly, the EPOS vending control apparatus 20 further comprises means for sampling characteristic vending machine control output signals for each vending machine connected to the EPOS vending control apparatus 20. Means are also provided for extracting vending machine identification parameters from the sampled vending machine signals. The EPOS vending control apparatus 20 can then use the vending machine identification parameters to select and write an interface control program to the adaptive vending machine communications interface 36 to facilitate processing of characteristic vending machine control output signals received from the vending machine 24 and generating characteristic vending machine control input signals for processing by the vending machine 24.

The adaptive communications interfaces 32, 36 each comprise means for extracting point of sales data and vending machine data from the characteristic output signals received from the EPOS systems 22 and/or the vending machines 24. Once extracted the point of sales device data and vending machine data is transmitted to the main vending control unit 26.

As shown in FIG. 5, the control apparatus 20 is connected to at least one hub computer 58 via a further communications link 60 for the transmission of the point of sales data and vending machine data extracted from the characteristic output signals. It will be understood that the point of sales data and vending machine data includes data relating to transactions including both products vended from a vending machine 3 and other non-vended products in a transaction. The main control unit 26 thus receives data relating to all vended products once they have been dispensed from the vending machine 24. The point of sales data and vending machine data transmitted from the main vending control unit 26 is time and/or date stamped according to the time and date of the transaction.

The main vending control unit 26 further comprises means to monitor the quantity of each product in a vending machine 24, as well as means to transmit alerts in response to signals received from a vending machine 24 indicating that levels of a product are below a minimum specified level. Such alerts may be in the form of a prompt on an EPOS system 22, a Simple Message Service (SMS) text message and/or an e-mail message.

The hub computer 58 is also able to process the point of sales data and vending machine data into reports detailing the dispensing activity of individual vending machines 24, as well as a collective group of vending machines 24 located at the same location or a multiple remote locations. FIGS. 12 to 15 show examples of reports which are able to be generated at the hub computer 58.

FIG. 6 shows a configuration in which outlets 68 are able to connect to the hub computer 58 via a network such as the Internet 62 to facilitate online remote monitoring of vending machines in a single or multiple locations. The vending machines 24 will also have the ability to send a “Current Status Update” to a designated web server which will enable the constant online remote monitoring of all vending machines in various locations throughout a specified territory or country.

FIG. 7 is the first part of a flow diagram showing a process for vending a product from a vending machine. At step 100, the EPOS operator authenticates him or herself to the EPOS system. A failed authentication attempt by the EPOS operator will, at step 110, result in the operator being blocked from having access to functionality of the EPOS system. At step 120, an EPOS operator, in response to a request received from a customer wanting to purchase a product in a vending machine, activates a vending option on the EPOS system. Such a vending option will enable the operator to identify the product to be vended on display means associated with the EPOS system. At step 130, the operator selects the product to be vended by appropriate interaction with input means associated with the EPOS system. Such input means may be a touch screen displaying images of icons representing various products able to be dispensed by the vending machines which are connected to the EPOS system. Alternatively, input means may be provided by a keyboard, whereby an operator is able to use the keyboard perform the required selection. At step 140, and for certain categories of products for which proof of age is required for purchase, age verification functionality on the EPOS system is activated. This verifies that the operator is the required age to vend the particular product and also, on confirmation that the operator is permitted to sell the product, prompts the operator to request that the customer verify their age before allowing the vend to proceed. The EPOS system will thus prompt the operator to verify their age and input a confirmation that the customer is old enough to purchase the desired goods. At step 150, if the operator is not the required minimum age, or if an operator has failed to produce the required age verification input for the customer, the vend will not proceed.

At step 160, the EPOS system encodes the selection by the operator into a vend request and transmits the vend request as a characteristic EPOS control output signal to the adaptive EPOS communications interface at the control apparatus. At step 170, the adaptive EPOS communications interface converts the characteristic EPOS control output signal into a standardised EPOS control output signal which is able to be processed by the main vending control unit. At step 180, the standardised EPOS control output signal generated at step 170 is converted into a standardised vending machine control input signal. At step 190, the vending machine control input signal is transmitted to the adaptive vending machine communications interface where it is converted into a characteristic vending machine control input signal which is suitable for processing by the vending machine and encodes the original vend instruction issued by the operator at the EPOS system to dispense the desired product.

FIG. 8 shows the subsequent steps in the vending process of FIG. 7. At step 200, the characteristic vending machine control input signal is sent to the specific vending machine needed to vend the requested product. In response to the characteristic vending machine control input signal the product is either successfully vended at step 210, or possibly due to an error at the vending machine, or if the vending machine is out of stock, it is not vended at step 220.

If the product is successfully vended, at step 230, a characteristic vending machine control output signal encoding an indication that the product has been successfully dispensed is sent from the vending machine to the adaptive vending machine communications interface. Alternatively, if the vend is unsuccessful, a characteristic vending machine control output signal encoding a confirmation indicating the product has not been successfully dispensed is sent from the vending machine to the adaptive vending machine communications interface at 240.

At step 250, the characteristic vending machine control output signal is converted to a standardised vending machine control output signal by the adaptive vending machine communications interface and sent onto the main vending control unit for processing. At step 260, the main vending control unit generates a standardised EPOS control input signal in response to the characteristic vending machine control output signal received. This standardised EPOS control input signal is sent from the main control unit to the adaptive EPOS communications interface, and at step 270, it is converted into a characteristic EPOS input signal which can be processed by the EPOS system that originally issued the vend request at step 130. Information received at the main vending control unit, including information relating to both successful and not successful vends is also transmitted for reporting purposes to a central hub computer at step 280.

If the signal at step 230 has encoded a confirmation that the vending machine has dispensed the product, the costs for the dispensed product are added to a customer invoice at step 290 by the EPOS system. The confirmation is also displayed on display means associated with the EPOS system. Alternatively, if the signal at step 230 encodes a failed vend confirmation, then, at step 300, the costs for the dispensed product are not added to a customer invoice and the operator is alerted to the fact the product was not dispensed by the vending machine.

FIG. 9 is a further flow diagram showing the higher level steps in a process for vending a product according to the invention. At step 400, the customer requests a product which is available from a vending machine in an outlet. At step 410, the operator/cashier touches or presses a vend button or icon representing that product on the EPOS system. At step 420, a product selection panel is rendered on the vending machine from which an operator, at step 430, selects a product to vend. If the operator does not wish to proceed with the product vend then a cancellation may be made and the product vend process ends at step 700.

At step 440, a determination is made as to whether the operator is authorised to vend the product. If not, then, at step 450, an unauthorised to vend prompt is displayed on the EPOS system and the vend process ends at step 700. At step 460, a determination is made as to whether customer age verification functionality is required for purchase of the desired products. If verification is required then the customer age verification functionality is activated at step 470. If the customer is not eligible to purchase the goods, then the process returns to step 450 and an unauthorised to vend prompt is displayed on the EPOS system, and the vend process ends at step 700. Conversely, if verification is not required, or if the customer satisfies the customer age verification requirements, then the characteristic EPOS control output signal encoding a vend request instruction is transmitted at step 480 and the product is vended. The EPOS vending control apparatus handles the vend request at step 490.

A check is then made at step 500 as to whether the vend request was validly completed. If it was, then the cost of the vended product is added to the sales invoice at step 510. If it was not, then the process returns to step 450 and an unauthorised to vend prompt is displayed on the EPOS system, and the vend process ends at step 700. At step 520, if one or more products failed to vend, then a vend error prompt is displayed. A re-route option is provided at step 530 which provides that if a specific vending machine is unable to vend a requested product then a vend request for the requested product is directed to an alternative vending machine. Such a re-route option returns the process to step 480. If no re-route option is provided, as at step 540, then the vend process ends at step 700.

Aspects of the present invention have been described by way of example only and it should be appreciated that additions and/or modifications may be made thereto without departing from the scope thereof as defined in the appended claims.

1. An electronic point of sales (EPOS) vending control apparatus for connecting different types of electronic point of sales systems with different types of vending machines, each type of EPOS system and vending machine having characteristic control inputs,
characterised in that the control apparatus comprises a main vending control unit connected to at least one vending machine and at least one EPOS system by a communications link for the transmission of characteristic EPOS control input signals for controlling the EPOS system and characteristic vending machine control input signals for controlling the vending machine from the EPOS system,
the control apparatus operating an adaptive EPOS communications interface for translating standardised EPOS control input signals transmitted from the main vending control unit into characteristic EPOS control input signals for transmission to the EPOS system, and an adaptive vending machine communications interface for converting standardised vending machine control inputs signals transmitted from the main vending control unit into characteristic vending machine control input signals for transmission to the vending machine.

2. The electronic point of sales (EPOS) vending control apparatus as claimed in claim 1, in which the adaptive EPOS communications interface is further configured to translate characteristic EPOS control output signals transmitted from the EPOS system into standardised EPOS control output signals for processing by the main vending control unit.

3. The electronic point of sales (EPOS) vending control apparatus as claimed in claim 1, in which the adaptive vending machine communications interface is further configured to translate characteristic vending machine control output signals transmitted from the vending machine into standardised vending machine control output signals for processing by the main vending control unit.

4. The electronic point of sales (EPOS) vending control apparatus as claimed in claim 1, in which the main vending control unit is connected to a database of interface control programs.

5. The electronic point of sales (EPOS) vending control apparatus as claimed in claim 4, in which some of the interface control programs, when executed on the adaptive EPOS communications interface, provide functionality required to generate characteristic EPOS control input signals and to process characteristic EPOS control output signals for an EPOS system.

6. The electronic point of sales (EPOS) vending control apparatus as claimed in claim 4, in which others of said interface control programs, when executed on the vending machine communications interface, provides functionality required to generate characteristic vending machine control input signals and to process characteristic vending machine control output signals for a vending machine.

7. The electronic point of sales (EPOS) vending control apparatus as claimed in claim 4, in which associated with the database of interface control programs is an EPOS configuration file which stores configuration parameters which are provided as input to the interface control programs.

8. The electronic point of sales (EPOS) vending control apparatus as claimed in claim 4, in which the interface control programs are arranged in the database in a dynamic linked library structure.

9. The electronic point of sales (EPOS) vending control apparatus as claimed in claim 4, in which the EPOS vending control apparatus further comprises means for sampling characteristic EPOS control output signals for an EPOS system on connection to the EPOS vending control apparatus, and means for extracting EPOS system identification parameters from the sampled EPOS signals.

10. The electronic point of sales (EPOS) vending control apparatus as claimed in claim 9, in which the EPOS vending control apparatus uses the EPOS system identification parameters to select and write an interface control program to the adaptive EPOS communications interface to facilitate processing of characteristic EPOS control output signals received from the EPOS system and generating characteristic EPOS control input signals for the EPOS system.

11. The electronic point of sales (EPOS) vending control apparatus as claimed in claim 4, in which the EPOS vending control apparatus further comprises means for sampling characteristic vending machine control output signals for a vending machine on connection to the EPOS vending control apparatus, and means for extracting vending machine identification parameters from the sampled vending machine signals.

12. The electronic point of sales (EPOS) vending control apparatus as claimed in claim 11, in which the EPOS vending control apparatus uses the vending machine identification parameters to select and write an interface control program to the adaptive vending machine communications interface to facilitate processing of characteristic vending machine control output signals received from the vending machine and generating characteristic vending machine control input signals for processing by the vending machine.

13. The electronic point of sales (EPOS) vending control apparatus as claimed in claim 1, in which the adaptive EPOS communications interface and the adaptive vending machine communications interface are stored in the control apparatus.

14. The electronic point of sales (EPOS) vending control apparatus as claimed in claim 1, in which the adaptive communications interfaces each comprise means for extracting point of sales terminal data and/or vending machine data from the characteristic EPOS control output signals received from the EPOS systems and/or the characteristic vending machine control output signals received from vending machines coupled to the control apparatus.

15. The electronic point of sales (EPOS) vending control apparatus as claimed in claim 14, in which the extracted point of sales device data and/or vending machine data is transmitted to the main vending control unit.

16. The electronic point of sales (EPOS) vending control apparatus as claimed in claim 15, in which the main vending control unit is connected to at least one hub computer via a further communications link for the transmission of the point of sales data and vending machine data.

17. The electronic point of sales (EPOS) vending control apparatus as claimed in claim 15, in which the point of sales data and vending machine data includes data relating to transactions including both products vended from a vending machine and other non-vended products in a transaction.

18. The electronic point of sales (EPOS) vending control apparatus as claimed in claim 15, in which the point of sales data and vending machine data transmitted from the main vending control unit is time and/or date stamped according to the time and date of the transaction.

19. The electronic point of sales (EPOS) vending control apparatus as claimed in claim 15, in which the hub computer is able to process the point of sales data and vending machine data into reports detailing sales activity and/or the dispensing activity of one or more vending machines.

20. The electronic point of sales (EPOS) vending control apparatus as claimed in claim 1, in which an operator must input authentication information to an EPOS system in order to operate and gain access to the functionality of the EPOS system.

21. The electronic point of sales (EPOS) vending control apparatus as claimed in claim 20, in which authentication of an operator involves the operator inputting a password into a login or verification routine running on an EPOS system.

22. The electronic point of sales (EPOS) vending control apparatus as claimed in claim 20, in which authentication of an operator involves the operator passing a swipe card through a reader associated with the EPOS system, whereby the required verification information is obtainable from the swipe card by the reader and then transmitted to the EPOS system.

23. The electronic point of sales (EPOS) vending control apparatus as claimed in claim 20, in which authentication involves the use of biometric methods including finger print readers or iris scanning technologies.

24. The electronic point of sales (EPOS) vending control apparatus as claimed in claim 1, in which instructions for the vending machine to dispense a product for a transaction are initially encoded in a characteristic EPOS control output signal transmitted from an EPOS system connected to the EPOS vending control apparatus.

25. The electronic point of sales (EPOS) vending control apparatus as claimed in claim 1, in which each EPOS system operates a vending machine control application which provides an interactive interface on the EPOS system from which operators can select a product to be dispensed from a vending machine.

26. The electronic point of sales (EPOS) vending control apparatus as claimed in claim 1, in which the EPOS system comprises a touch screen and the interactive interface is icon based, each product able to be dispensed from the vending machine being represented as an icon on the touch screen.

27. The electronic point of sales (EPOS) vending control apparatus as claimed in claim 26, in which the touch screen associated with an EPOS system is able to be configured with all information corresponding to the layout of columns and slots in a vending machine.

28. The electronic point of sales (EPOS) vending control apparatus as claimed in claim 1, in which each EPOS system comprises a keyboard and each product is able to be dispensed from the vending machine by pressing a predefined key on the keyboard.

29. The electronic point of sales (EPOS) vending control apparatus as claimed in claim 1, wherein in the event that a specific vending machine is unable to vend a requested product then a vend request for the requested product is directed to an alternative vending machine to dispense the requested product.

30. The electronic point of sales (EPOS) vending control apparatus as claimed in claim 1, in which before a cost for a product vended from a vending machine is added to a customer invoice the EPOS system must receive a characteristic EPOS control input signal encoding a confirmation that the vending machine has dispensed the product.

31. The electronic point of sales (EPOS) vending control apparatus as claimed in claim 30, in which when the confirmation is received it is rendered on display means associated with the EPOS system.

32. The electronic point of sales (EPOS) vending control apparatus as claimed in claim 1, in which a vend from a vending machine is recorded against an operator authenticated to the EPOS system.

33. The electronic point of sales (EPOS) vending control apparatus as claimed in claim 1, in which the EPOS system comprises customer age verification functionality in the form of a visual prompt on the display means associated with the EPOS system, the prompt instructing the operator to request a customer to produce age verification.

34. The electronic point of sales (EPOS) vending control apparatus as claimed in claim 1, in which the EPOS system comprises customer age verification functionality involving scanning a card encoding the age of the customer.

35. The electronic point of sales (EPOS) vending control apparatus as claimed in claim 33, in which the EPOS system is adapted to store details relating to age verification of a customer.

36. The electronic point of sales (EPOS) vending control apparatus as claimed in claim 1, in which each EPOS system maintains a personal details database comprising personal details of each operator, whereby access to functionality on each EPOS system needed to vend specific products from a vending machine is controllable according to personal details of the operator in the database.

37. The electronic point of sales (EPOS) vending control apparatus as claimed in claim 1, in which the main control unit receives data relating to all vended products once they have been dispensed from a vending machine.

38. The electronic point of sales (EPOS) vending control apparatus as claimed in claim 1, in which the main vending control unit comprises means to transmit alerts in response to signals received from a vending machine indicating that levels of product remaining in the vending machine are below a minimum specified level.

39. The electronic point of sales (EPOS) vending control apparatus as claimed in claim 38, in which alerts are in the form of a prompt on an EPOS system, a simple messaging service (SMS) text message and/or an e-mail message.

40. The electronic point of sales (EPOS) vending control apparatus as claimed in claim 1, in which the main vending control unit is adapted to transmit status information to a web-server to facilitate online remote monitoring of vending machines in a single or in multiple locations.

41. The electronic point of sales (EPOS) vending control apparatus as claimed in claim 1, in which touch panels associated with an EPOS system are configurable to present a graphical representations corresponding to the physical layout of products in the vending machine.

42. (canceled)

43. The electronic point of sales (EPOS) vending control apparatus as claimed in claim 2, in which the adaptive vending machine communications interface is further configured to translate characteristic vending machine control output signals transmitted from the vending machine into standardised vending machine control output signals for processing by the main vending control unit.

44. The electronic point of sales (EPOS) vending control apparatus as claimed in claim 5, in which others of said interface control programs, when executed on the vending machine communications interface, provides functionality required to generate characteristic vending machine control input signals and to process characteristic vending machine control output signals for a vending machine.

45. The electronic point of sales (EPOS) vending control apparatus as claimed in claim 34, in which the EPOS system is adapted to store details relating to age verification of a customer.
